(19) United States
(12) Patent Application Publication
(10) Pub. No.: US 2011/0129377 A1
(43) Pub. Date: Jun. 2, 2011

(54) Scroll Compressor and Method for Manufacturing the Same

(75) Inventors: Chi-Shun Huang, Taoyuan Hsien (TW); Tsung-Han Tsai, Taoyuan Hsien (TW)

(73) Assignee: HANBELL PRECISE MACHINERY CO., LTD., Tao-Yuan Hsien (TW)

(21) Appl. No.: 12/950,031

(22) Filed: Nov. 19, 2010

(30) Foreign Application Priority Data
Nov. 27, 2009 (TW) 098140469

(51) Int. Cl. F01C 1/02; B23P 15/00

(52) U.S. Cl. 418/55.1; 29/888.022

(57) ABSTRACT

The present invention discloses a scroll compressor and a method for manufacturing the same. The scroll compressor comprises a housing assembly, a motor assembly, a major shaft supporting base, a rotating shaft, and a compressing assembly; the housing assembly comprises a bottom case and a top cover; the motor assembly comprises a fixed unit and a rotating unit; the compressing assembly comprises a fixed compressing member and a rotating compressing member; the method for manufacturing the scroll compressor comprises the steps of: mounting the fixed unit in the bottom case; combining the rotating unit with the rotating shaft; fitting the rotating unit on the center of the fixed unit; disposing the major shaft supporting base on the rotating shaft; disposing the rotating compressing member and the fixed compressing member in the bottom case; and combining the top cover with an upper opening of the bottom case and then finishing the manufacture of the scroll compressor.

### BACKGROUND OF THE INVENTION

1. Field of the Invention

The present invention relates to a scroll compressor and a method for manufacturing the same, and more particularly to a scroll compressor which includes a two-piece case and a plurality of positioning elements, wherein the components in the case are fabricated with a layer staking manner.

2. Description of the Prior Art

Since the appearance of a scroll compressor, which has been become the key product of international major manufacturers for development because of its several advantage, such as smaller vibration, fewer noise, higher working efficiency, and fewer components.

The working principle of the scroll compressor is the following: a motor drives a rotating shaft for rotating, and then makes a orbiting scroll do a revolution rotation related to a fixed scroll, so as to continuously produce a closed space having a volume decreased from outside to inside between two scrolls. In this way, when a fluid with low temperature and low pressure enter the closed space, via the process of compression, the fluid can be transformed to the fluid with high temperature and high pressure, and the fluid is discharged from the center of the fixed scroll, so as to complete the process of gas compressing.

Regarding the case of the scroll compressor, the structure of the traditional case is designed as an entire-closed type, that is to say, each parts of the case are connected with each other by welding, and the motor and the scroll assembly are enclosed in the case and isolated from outside. Although the cost of the entire-closed type of case structure is lower, the components inside the case can not be taken out easily. If the components need to be repaired or maintained, it usually requires greatly high cost, so that the entire-closed type of case structure is uneconomical.

Therefore, a case structure with semi-closed type has been developed. Similar to the case structure with entire-closed type, conventional case structure with semi-closed type is composed of a plurality parts and the necessary components are packaged inside the case. However, the plurality of parts of the semi-closed type of case are fastened by screwing, thus the case can be disassembled and separated easily, so that the maintaining for the inner components is very convenient.

However, the conventional case structure with semi-closed type is usually composed of three or four parts, thus each of the inner components (such as a motor, a bearing seat and a fixed scroll) might be fixed on different case parts. While fabricating the scroll compressor, it is necessary to combine the case parts with the corresponding inner components, and then combine all parts of assembly to each other, so as to complete the fabrication of the compressor. Nevertheless, this kind of structure and fabricating manner requires the repeatedly reverse for the assemblies. It not only is laborious, but also might damage the components in the process of fabrication. Furthermore, owing to each inner components are positioned their axle center by different case assemblies, the condition of drift mandrel often happens.

In view of this, it is necessary to provide an improved scroll compressor, which can improve the case structure and the positioning manner, so as to save time and effort for manufacturing the scroll compressor.

### SUMMARY OF THE INVENTION

In view of the above shortcomings of the prior art, the inventor of the present invention resorted to past experience, imagination, and creativity, performed experiments and researches repeatedly, and eventually devised the present invention, a scroll compressor and a method for manufacturing the same.

The major objective of the present invention is to provide the scroll compressor, which improves the case structure and the connection manner of the components, so as to simplify the manufacturing steps and save labor power and time.

Another objective of the present invention is to provide the scroll compressor, which provides a two-piece of the case structure, so as to reduce the manufacturing costs.

Further objective of the present invention is to provide the scroll compressor, which improves the case structure and provides positioning elements, so as to precisely position the axle center of the components in the scroll compressor, prevent the axle center from offset, and increase the whole use efficiency.

According to the above objective, the present invention provides a scroll compressor comprising: a housing assembly comprising a bottom case and a top cover, wherein the bottom case has an accommodating space, and the top cover being disposed on an upper opening of the bottom case, an inner surface of the bottom case comprising a plurality of first positioning elements and a plurality of second positioning elements, wherein the plurality of second positioning elements are located on the upper position related to the plurality of first positioning elements; a motor assembly being disposed in the accommodating space and an axle center of the motor assembly being positioned by the plurality of first positioning elements, the motor assembly comprising a fixed unit and a rotating unit, wherein the fixed unit is able to provide a power required by the rotating unit for rotating; a major shaft supporting base being disposed on the upper position related to the motor assembly and fixed on the plurality of second positioning elements, wherein the axle center of the major shaft supporting base is positioned by fitting the major shaft supporting base with the inner surface of the bottom case; a rotating shaft being inserted in the motor assembly and the major shaft supporting base, wherein the rotating shaft is driven by the motor assembly for rotating; and a compressing assembly being disposed on the upper position related to the major shaft supporting base and comprising a fixed compressing member and a rotating compressing member, wherein the fixed compressing member is located on the upper position related to the rotating compressing member, and the fixed compressing member and the rotating compressing member being engaged to each other, the axle center of the fixed compressing member being positioned by the major shaft supporting base, and a bottom end of the rotating compressing member being connected with the rotating shaft.

Further objective of the present invention is to provide the method for manufacturing the scroll compressor, which installs the inner components in the case by the manner of layer stacking, so as to saving the manufacturing time, increase the manufacturing efficiency, and prevent the components from damage during the process of manufacturing.

According to the above objective, the present invention provides a method for manufacturing the scroll compressor comprising the steps of: (1) providing a bottom case; (2) providing a fixed unit of a motor assembly, disposing the fixed unit in a accommodating space of the bottom case, and positioning an axle center of the fixed unit by a plurality of first positioning elements in the bottom case; (3) providing a rotating unit of the motor assembly; (4) providing a rotating shaft, and disposing and fixing the rotating shaft on the center of the rotating unit; (5) disposing the rotating unit and the rotating shaft on the center of the fixed unit; (6) providing a major shaft supporting base, disposing the major shaft supporting base on the rotating shaft and above the motor assembly; (7) positioning the axle center of the major shaft supporting base by an inner surface of the bottom case, and fixing the major shaft supporting base on a plurality of second positioning elements in the bottom case; (8) providing a rotating compressing member, connecting a bottom end of the rotating compressing member to the rotating shaft, and disposing the rotating compressing member above the major shaft supporting base; (9) providing a fixed compressing member, engaging the fixed compressing member with the rotating compressing member, and positioning the axle center of the fixed compressing member by the major shaft supporting base; and (10) providing a top cover, and disposing the top cover on an upper opening of the bottom case for sealing the accommodating space.

The present invention further provides a method for manufacturing the scroll compressor comprising the steps of: (1) providing a bottom case; (2) providing a fixed unit of a motor assembly, disposing the fixed unit in a accommodating space of the bottom case, and positioning an axle center of the fixed unit by a plurality of first positioning elements in the bottom case; (3) providing a rotating unit of the motor assembly; (4) providing a rotating shaft, and disposing and fixing the rotating shaft on the center of the rotating unit; (5) providing a major shaft supporting base, disposing the major shaft supporting base on the rotating shaft and above the rotating unit; (6) disposing the rotating unit and the rotating shaft on the center of the fixed unit, and disposing the major shaft supporting base in the accommodating space of the bottom case simultaneously; (7) positioning the axle center of the major shaft supporting base by an inner surface of the bottom case, and fixing the major shaft supporting base on a plurality of second positioning elements in the bottom case; (8) providing a rotating compressing member, connecting a bottom end of the rotating compressing member to the rotating shaft, and disposing the rotating compressing member above the major shaft supporting base; (9) providing a fixed compressing member, engaging the fixed compressing member with the rotating compressing member, and positioning the axle center of the fixed compressing member by the major shaft supporting base; and (10) providing a top cover, and disposing the top cover on an upper opening of the bottom case for sealing the accommodating space.

### BRIEF DESCRIPTION OF THE DRAWINGS

For a complete understanding of the aspects, structures and techniques of the invention, reference should be made to the following detailed description and accompanying drawings wherein:

FIG. 1 is an exploded diagram of a scroll compressor according to a first preferred embodiment of the present invention;

FIG. 2 is an exploded diagram from another angle of view of the scroll compressor according to the first preferred embodiment of the present invention;

FIG. 3 is a perspective diagram of the scroll compressor according to the first preferred embodiment of the present invention;

FIG. 4 is a cross-section diagram of the scroll compressor according to the first preferred embodiment of the present invention;

FIG. 5 is a perspective diagram of a bottom case of the scroll compressor according to the first preferred embodiment of the present invention;

FIG. 6 is a flow chart diagram for manufacturing the scroll compressor according to the first preferred embodiment of the present invention; and

FIG. 7 is a flow chart diagram for manufacturing the scroll compressor according to a second preferred embodiment of the present invention.

### DETAILED DESCRIPTION OF THE PREFERRED EMBODIMENTS

To achieve the foregoing objectives and effects, the inventors improve the case structure of the scroll compressor, provide positioning elements, and improve the fabrication manner for inner components, thus achieving a scroll compressor and a method for manufacturing the same of the present invention. Hereinafter, the scroll compressor and the method for manufacturing the same according to a first and a second preferred embodiment of the present invention are described in detail to illustrate the system structure and the characteristics of the present invention.

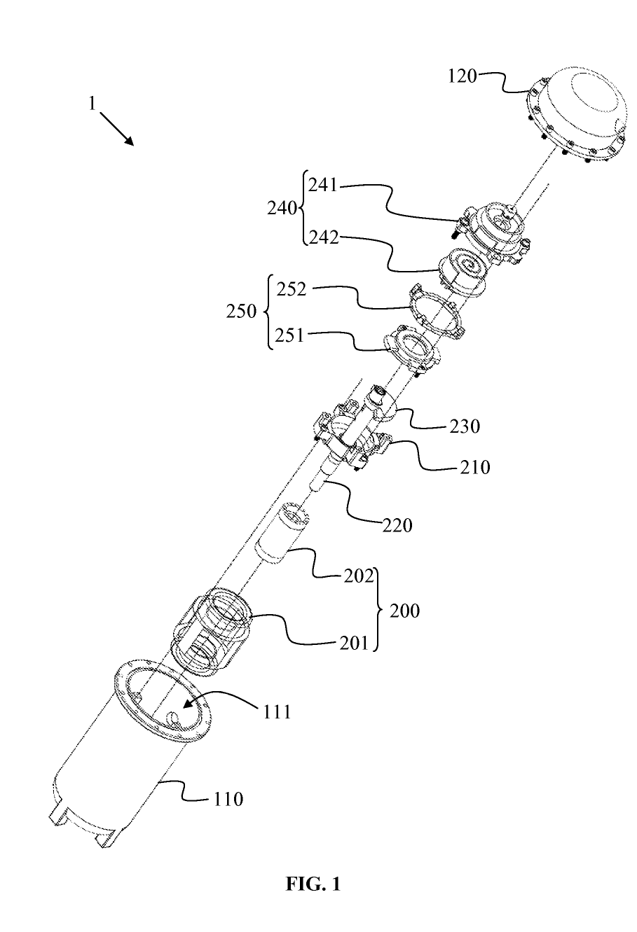

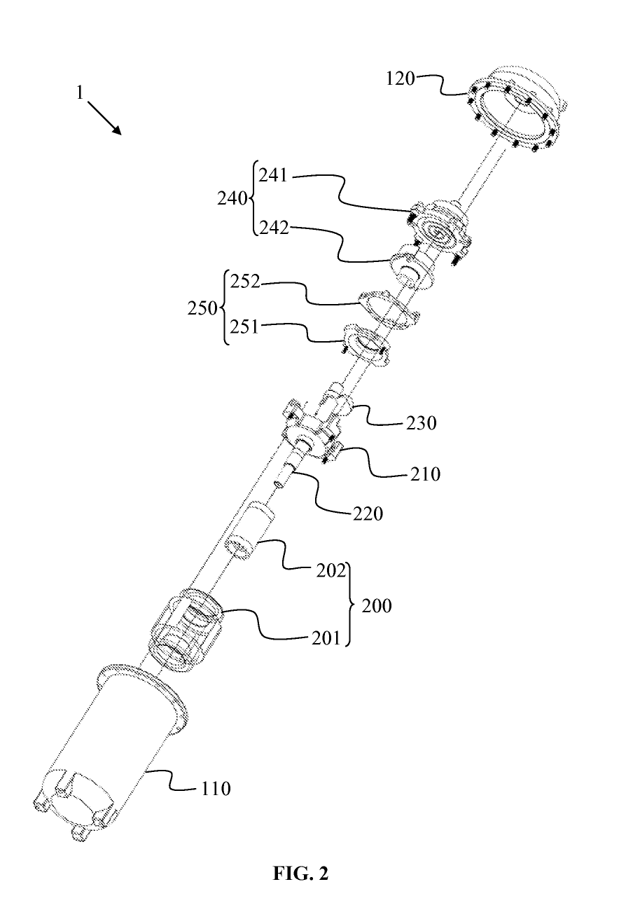

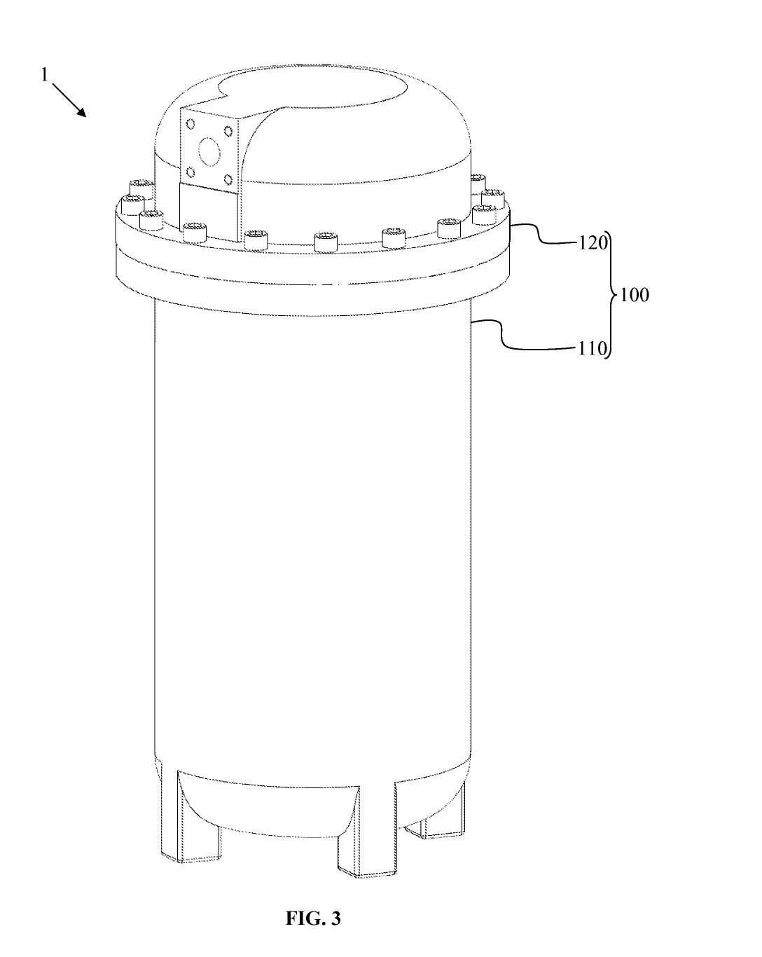

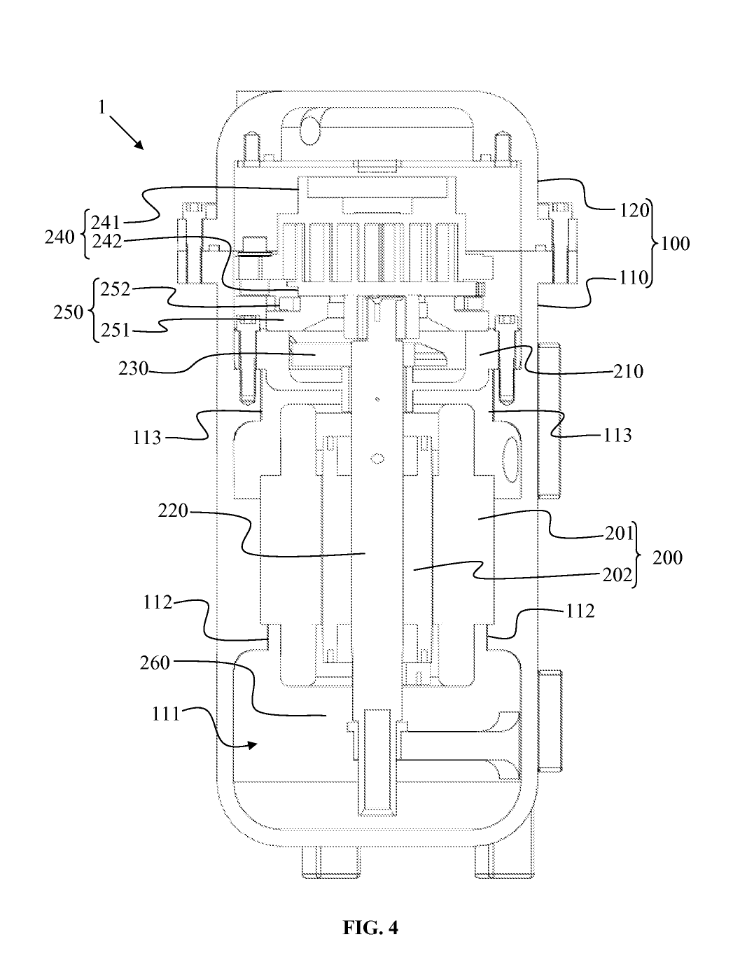

Referring to FIG. 1˜FIG. 4, wherein FIG. 1 is an exploded diagram of the scroll compressor according to the first preferred embodiment of the present invention, FIG. 2 is an exploded diagram from another angle of view of the scroll compressor according to the first preferred embodiment of the present invention, FIG. 3 is a perspective diagram of the scroll compressor according to the first preferred embodiment of the present invention, and FIG. 4 is a cross-section diagram of the scroll compressor according to the first preferred embodiment of the present invention. The scroll compressor 100 comprises a housing assembly 100, a motor assembly 200, a major shaft supporting base 210, a rotating shaft 220, a balancing unit 230, a compressing assembly 240, a supporting assembly 250, and a lower shaft supporting base 260.

The housing assembly 100 comprises a bottom case 110 and a top cover 120. The bottom case 110 has an accommodating space 111, and the top cover 120 is disposed on an upper opening of the bottom case 110. An inner surface of the bottom case 110 comprises a plurality of first positioning elements 112 and a plurality of second positioning elements 113, wherein the plurality of second positioning elements 113 are located on the upper position related to the plurality of first positioning elements 112. The connecting manner between the bottom case 110 and the top cover 120 utilizes a screw fastening manner, however, in practical applications, the bottom case 110 and the top cover 120 also can be connected by a welding manner or a close fitting manner.

The motor assembly 200 is disposed in the accommodating space 111 and an axle center of the motor assembly 200 is positioned by the plurality of first positioning elements 112. The motor assembly 200 comprises a fixed unit 201 and a rotating unit 202, wherein the fixed unit 201 is able to provide a power required by the rotating unit 202 for rotating. The connecting manner between the motor assembly 200 and the plurality of first positioning elements 112 utilizes a screw fastening manner, however, in practical applications, the motor assembly 200 and the plurality of first positioning elements 112 also can be connected by a welding manner or a close fitting manner.

The major shaft supporting base 210 is disposed on the upper position related to the motor assembly 200 and fixed on the plurality of second positioning elements 113. The axle center of the major shaft supporting base 210 is positioned by fitting the major shaft supporting base 210 with the inner surface of the bottom case 110. The connecting manner between the major shaft supporting base 210 and the plurality of second positioning elements 113 utilizes a screw fastening manner, however, in practical applications, the major shaft supporting base 210 and the plurality of second positioning elements 113 also can be connected by a welding manner or a close fitting manner.

The rotating shaft 220 is inserted in the motor assembly 200 and the major shaft supporting base 210, wherein the rotating shaft 220 is driven by the motor assembly 200 for rotating. More precisely, the rotation of the rotating shaft 220 is driven by the rotating unit 202.

The balancing unit 230 is disposed on the rotating shaft 220 and located on the upper position related to the major shaft supporting base 210, wherein the balancing unit 230 can balance the gravity center of the rotating shaft 220 when the rotating shaft 220 rotates.

The compressing assembly 240 is disposed on the upper position related to the major shaft supporting base 210 and comprises a fixed compressing member 241 and a rotating compressing member 242. The fixed compressing member 241 is located on the upper position related to the rotating compressing member 242, and the fixed compressing member 241 and the rotating compressing member 242 are engaged to each other. The axle center of the fixed compressing member 241 is positioned by the major shaft supporting base 210, and a bottom end of the rotating compressing member 242 is connected with the rotating shaft 220. The connecting manner between the fixed compressing member 241 and the major shaft supporting base 210 utilizes a screw fastening manner, however, in practical applications, the fixed compressing member 241 and the major shaft supporting base 210 also can be connected by a close fitting manner.

The supporting assembly 250 is disposed between the major shaft supporting base 210 and the rotating compressing member 242, and the supporting assembly 250 comprises a supporting frame 251 and an autorotation-restricting ring 252. The supporting frame 251 can support the rotating compressing member 242, and the autorotation-restricting ring 252 can restrict the autorotation of the rotating compressing member 242.

The lower shaft supporting base 260 is disposed on the bottom of the inside of the bottom case 110. The lower shaft supporting base 260 is connected with the rotating shaft 220 and can position the axle center of the rotating shaft 220.

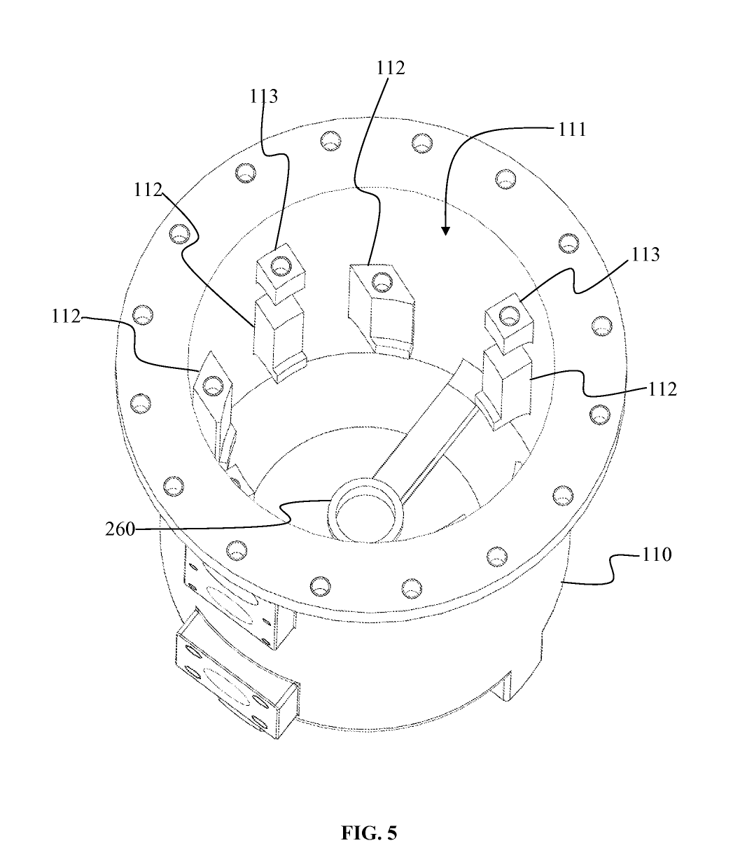

Referring to FIG. 5, which is a perspective diagram of a bottom case of the scroll compressor according to the first preferred embodiment of the present invention. The inner surface of the bottom case 110 is provided with the plurality of first positioning elements 112, the plurality of second positioning elements 113 and the lower shaft supporting base 260. The plurality of first positioning elements 112, the plurality of second positioning elements 113, the lower shaft supporting base 260, and the bottom case 110 are one-body formed and manufactured with a co-axis machining manner, so as to enhance the accuracy of the axle positioning of the motor assembly 200, the major shaft supporting base 210 and the rotating shaft 220.

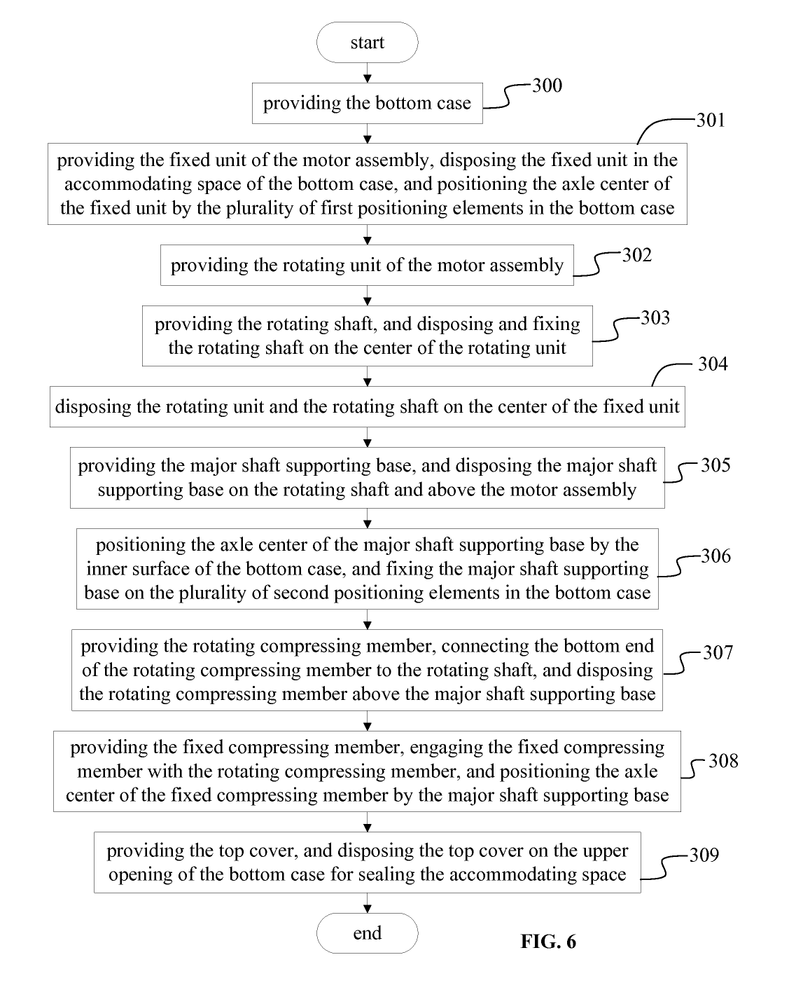

Referring to FIG. 6, which is a flow chart diagram for manufacturing the scroll compressor according to the first preferred embodiment of the present invention. The method for manufacturing the scroll compressor comprises the steps of: (step 300) providing the bottom case; (step 301) providing the fixed unit of the motor assembly, disposing the fixed unit in the accommodating space of the bottom case, and positioning the axle center of the fixed unit by the plurality of first positioning elements in the bottom case, wherein the connecting manner between the fixed unit and the plurality of first positioning elements utilizes a screw fastening manner, however, in practical applications, the fixed unit and the plurality of first positioning elements also being able to be connected by a welding manner or a close fitting manner; (step 302) providing the rotating unit of the motor assembly; (step 303) providing the rotating shaft, and disposing and fixing the rotating shaft on the center of the rotating unit; (step 304) disposing the rotating unit and the rotating shaft on the center of the fixed unit; (step 305) providing the major shaft supporting base, and disposing the major shaft supporting base on the rotating shaft and above the motor assembly; (step 306) positioning the axle center of the major shaft supporting base by the inner surface of the bottom case, and fixing the major shaft supporting base on the plurality of second positioning elements in the bottom case, wherein the connecting manner between the major shaft supporting base and the plurality of second positioning elements utilizes a screw fastening manner, however, in practical applications, the major shaft supporting base and the plurality of second positioning elements also being able to be connected by a welding manner or a close fitting manner; (step 307) providing the rotating compressing member, connecting the bottom end of the rotating compressing member to the rotating shaft, and disposing the rotating compressing member above the major shaft supporting base; (step 308) providing the fixed compressing member, engaging the fixed compressing member with the rotating compressing member, and positioning the axle center of the fixed compressing member by the major shaft supporting base, wherein the connecting manner between the fixed compressing member and the major shaft supporting base utilizes a screw fastening manner, however, in practical applications, the fixed compressing member and the major shaft supporting base also being able to be connected by a close fitting manner; and (step 309) providing the top cover, and disposing the top cover on the upper opening of the bottom case for sealing the accommodating space, wherein the connecting manner between the top cover and the bottom case utilizes a screw fastening manner, however, in practical applications, the top cover and the bottom case also being able to be connected by a welding manner or a close fitting manner.

In the above manufacturing method of the first preferred embodiment, after completing the step 306, there can be further provided with the balancing unit and the supporting assembly and dispose the two components on the rotating shaft in turn, and then going to step 307. Moreover, the fixed compressing member can be connected with the top cover prior to the disposition of the top cover on an upper opening of the bottom case and engaging the fixed compressing member with the rotating compressing member, and then position the axle center of the fixed compressing member by the major shaft supporting base.

Subsequently, introduce the second preferred embodiment of the present invention. The structure of the scroll compressor of the second preferred embodiment is almost the same as the structure of the first preferred embodiment, thus the structure of the scroll compressor of the second preferred embodiment is not described here again. The difference between the second preferred embodiment and the first preferred embodiment is the steps of the manufacturing method, and therefore the manufacturing method of the second preferred embodiment is described below.

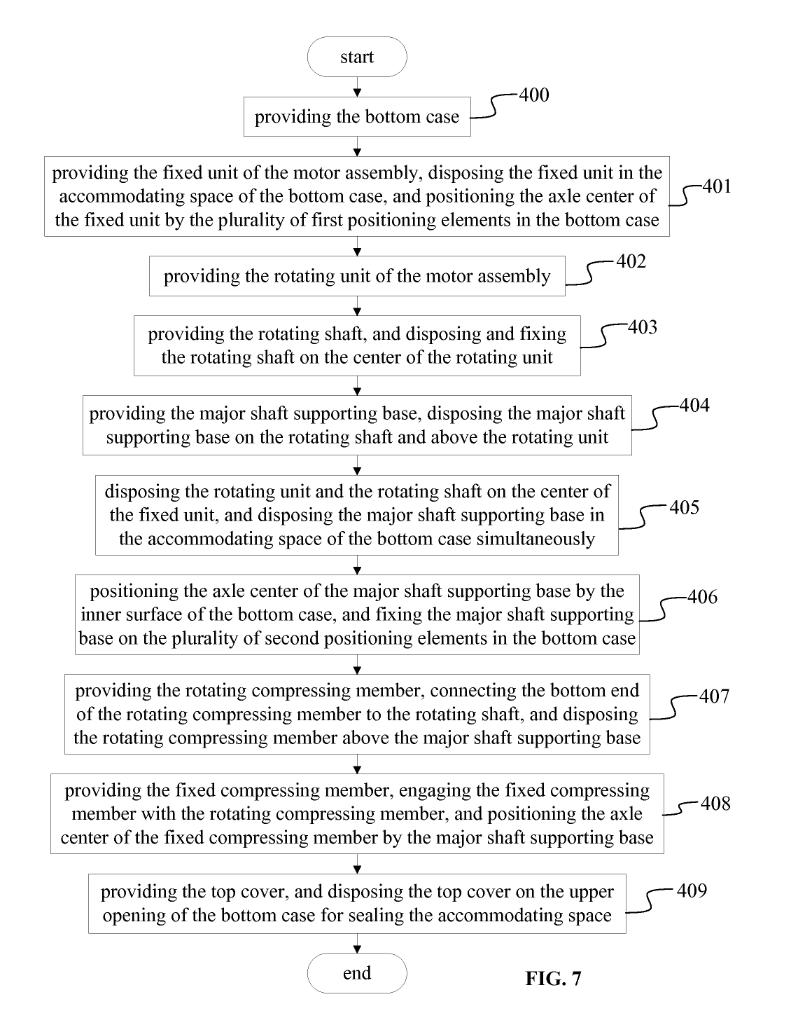

Referring to FIG. 7, which is a flow chart diagram for manufacturing the scroll compressor according to a second preferred embodiment of the present invention. The method for manufacturing the scroll compressor comprises the steps of: (step 400) providing the bottom case; (step 401) providing the fixed unit of the motor assembly, disposing the fixed unit in the accommodating space of the bottom case, and positioning the axle center of the fixed unit by the plurality of first positioning elements in the bottom case, wherein the connecting manner between the fixed unit and the plurality of first positioning elements utilizes a screw fastening manner, however, in practical applications, the fixed unit and the plurality of first positioning elements also being able to be connected by a welding manner or a close fitting manner; (step 402) providing the rotating unit of the motor assembly; (step 403) providing the rotating shaft, and disposing and fixing the rotating shaft on the center of the rotating unit; (step 404) providing the major shaft supporting base, disposing the major shaft supporting base on the rotating shaft and above the rotating unit; (Step 405) disposing the rotating unit and the rotating shaft on the center of the fixed unit, and disposing the major shaft supporting base in the accommodating space of the bottom case simultaneously, wherein the connecting manner between the motor assembly and the plurality of first positioning elements utilizes a screw fastening manner, however, in practical applications, the motor assembly and the plurality of first positioning elements also being able to be connected by a welding manner or a close fitting manner; (step 406) positioning the axle center of the major shaft supporting base by the inner surface of the bottom case, and fixing the major shaft supporting base on the plurality of second positioning elements in the bottom case, wherein the connecting manner between the major shaft supporting base and the plurality of second positioning elements utilizes a screw fastening manner, however, in practical applications, the major shaft supporting base and the plurality of second positioning elements also being able to be connected by a welding manner or a close fitting manner; (step 407) providing the rotating compressing member, connecting the bottom end of the rotating compressing member to the rotating shaft, and disposing the rotating compressing member above the major shaft supporting base; (step 408) providing the fixed compressing member, engaging the fixed compressing member with the rotating compressing member, and positioning the axle center of the fixed compressing member by the major shaft supporting base, wherein the connecting manner between the fixed compressing member and the major shaft supporting base utilizes a screw fastening manner, however, in practical applications, the fixed compressing member and the major shaft supporting base also being able to be connected by a close fitting manner; and (step 409) providing the top cover, and disposing the top cover on the upper opening of the bottom case for sealing the accommodating space, wherein the connecting manner between the top cover and the bottom case utilizes a screw fastening manner, however, in practical applications, the top cover and the bottom case also being able to be connected by a welding manner or a close fitting manner.

In the above manufacturing method of the first preferred embodiment, after completing the step 404, there can be further provided with the balancing unit and dispose it on the rotating shaft, and then going to step 405; after completing the step 406, there can be further provided with the supporting assembly and dispose it on the rotating shaft, and then going to step 407. Moreover, the fixed compressing member can be connected with the top cover prior to the disposition of the top cover on an upper opening of the bottom case and engaging the fixed compressing member with the rotating compressing member, and then position the axle center of the fixed compressing member by the major shaft supporting base.

By the detailed description of the overall structure and technical content of the present invention, the following advantages of the present invention can be derived:
1. The present invention improves the case structure of the scroll compressor to a two-piece type, it not only can save manufacturing costs, bus also can simplify the fabrication steps for the inner components, so as to save labor power and increase the manufacturing efficiency.
2. The improved case structure and the novel positioning elements of the present invention can accurately position the axle center of the inner components of the scroll compressor, so as to prevent the axle center from offset and increase the working efficiency of the scroll compressor.
3. The present invention fabricate the inner components by the manner of layer staking, it not only can save the manufacturing time, but also can prevent the inner components from damage during the process of fabrication, so as to elevate the yield rate of the products.

It should be understood that the embodiments of the present invention described herein are merely illustrative of the technical concepts and features of the present invention and are not meant to limit the scope of the invention. Those skilled in the art, after reading the present disclosure, will know how to practice the invention. Various variations or modifications can be made without departing from the spirit of the invention. All such equivalent variations and modifications are intended to be included within the scope of the invention.

As a result of continued thinking about the invention and modifications, the inventors finally work out the designs of the present invention that has many advantages as described above. The present invention meets the requirements for an invention patent, and the application for a patent is duly filed accordingly. It is expected that the invention could be examined at an early date and granted so as to protect the rights of the inventors.

What is claimed is:

1. A scroll compressor comprising:
a housing assembly comprising a bottom case and a top cover, wherein the bottom case has an accommodating space, and the top cover being disposed on an upper opening of the bottom case, an inner surface of the bottom case comprising a plurality of first positioning elements and a plurality of second positioning elements, wherein the plurality of second positioning elements are located on the upper position related to the plurality of first positioning elements;
a motor assembly being disposed in the accommodating space and an axle center of the motor assembly being positioned by the plurality of first positioning elements, the motor assembly comprising a fixed unit and a rotating unit, wherein the fixed unit is able to provide a power required by the rotating unit for rotating;
a major shaft supporting base being disposed on the upper position related to the motor assembly and fixed on the plurality of second positioning elements, wherein the axle center of the major shaft supporting base is positioned by fitting the major shaft supporting base with the inner surface of the bottom case;
a rotating shaft being inserted in the motor assembly and the major shaft supporting base, wherein the rotating shaft is driven by the motor assembly for rotating; and
a compressing assembly being disposed on the upper position related to the major shaft supporting base and comprising a fixed compressing member and a rotating compressing member, wherein the fixed compressing member is located on the upper position related to the rotating compressing member, and the fixed compressing member and the rotating compressing member being engaged to each other, the axle center of the fixed compressing member being positioned by the major shaft supporting base, and a bottom end of the rotating compressing member being connected with the rotating shaft.

2. The scroll compressor according to claim 1, wherein the connecting manner between the bottom case and the top cover is selected from the group consisting of: a screw fastening manner, a welding manner and a close fitting manner.

3. The scroll compressor according to claim 1, wherein the connecting manner between the motor assembly and the plurality of first positioning elements is selected from the group consisting of: a screw fastening manner, a welding manner and a close fitting manner.

4. The scroll compressor according to claim 1, wherein the connecting manner between the major shaft supporting base and the plurality of second positioning elements is selected from the group consisting of: a screw fastening manner, a welding manner and a close fitting manner.

5. The scroll compressor according to claim 1, wherein the fixed compressing member is connected with the major shaft supporting base, and the connecting manner being selected from the group consisting of: a screw fastening manner and a close fitting manner.

6. The scroll compressor according to claim 1, wherein the fixed compressing member is connected with the top cover, and the connecting manner being selected from the group consisting of: a screw fastening manner, a welding manner and a close fitting manner.

7. The scroll compressor according to claim 1, further comprising a lower shaft supporting base disposed on the bottom of the inside of the bottom case, wherein the lower shaft supporting base is connected with the rotating shaft and can position the axle center of the rotating shaft.

8. The scroll compressor according to claim 1, further comprising a balancing unit disposed on the rotating shaft and located on the upper position related to the major shaft supporting base, wherein the balancing unit can balance the gravity center of the rotating shaft when the rotating shaft rotates.

9. The scroll compressor according to claim 1, further comprising a supporting assembly disposed between the major shaft supporting base and the rotating compressing member, and the supporting assembly comprising a supporting frame and an autorotation-restricting ring, wherein the supporting frame can support the rotating compressing member, and the autorotation-restricting ring being able to restrict the autorotation of the rotating compressing member.

10. A method for manufacturing the scroll compressor comprising the steps of:
(1) providing a bottom case;
(2) providing a fixed unit of a motor assembly, disposing the fixed unit in a accommodating space of the bottom case, and positioning an axle center of the fixed unit by a plurality of first positioning elements in the bottom case;
(3) providing a rotating unit of the motor assembly;
(4) providing a rotating shaft, and disposing and fixing the rotating shaft on the center of the rotating unit;
(5) disposing the rotating unit and the rotating shaft on the center of the fixed unit;
(6) providing a major shaft supporting base, and disposing the major shaft supporting base on the rotating shaft and above the motor assembly;
(7) positioning the axle center of the major shaft supporting base by an inner surface of the bottom case, and fixing the major shaft supporting base on a plurality of second positioning elements in the bottom case;
(8) providing a rotating compressing member, connecting a bottom end of the rotating compressing member to the rotating shaft, and disposing the rotating compressing member above the major shaft supporting base;
(9) providing a fixed compressing member, engaging the fixed compressing member with the rotating compressing member, and positioning the axle center of the fixed compressing member by the major shaft supporting base; and
(10) providing a top cover, and disposing the top cover on an upper opening of the bottom case for sealing the accommodating space.

11. The method according to claim 10, wherein the connecting manner between the fixed unit and the plurality of first positioning elements is selected from the group consisting of: a screw fastening manner, a welding manner and a close fitting manner.

12. The method according to claim 10, wherein the connecting manner between the major shaft supporting base and the plurality of second positioning elements is selected from the group consisting of: a screw fastening manner, a welding manner and a close fitting manner.

13. The method according to claim 10, wherein the fixed compressing member is connected with the major shaft supporting base, and the connecting manner being selected from the group consisting of: a screw fastening manner and a close fitting manner.

14. The method according to claim 10, wherein the connecting manner of the bottom case and the top cover is selected from the group consisting of: a screw fastening manner, a welding manner and a close fitting manner.

15. A method for manufacturing the scroll compressor comprising the steps of:
(1) providing a bottom case;
(2) providing a fixed unit of a motor assembly, disposing the fixed unit in a accommodating space of the bottom case, and positioning an axle center of the fixed unit by a plurality of first positioning elements in the bottom case;
(3) providing a rotating unit of the motor assembly;
(4) providing a rotating shaft, and disposing and fixing the rotating shaft on the center of the rotating unit;
(5) providing a major shaft supporting base, disposing the major shaft supporting base on the rotating shaft and above the rotating unit;
(6) disposing the rotating unit and the rotating shaft on the center of the fixed unit, and disposing the major shaft supporting base in the accommodating space of the bottom case simultaneously;
(7) positioning the axle center of the major shaft supporting base by an inner surface of the bottom case, and fixing the major shaft supporting base on a plurality of second positioning elements in the bottom case;
(8) providing a rotating compressing member, connecting a bottom end of the rotating compressing member to the rotating shaft, and disposing the rotating compressing member above the major shaft supporting base;
(9) providing a fixed compressing member, engaging the fixed compressing member with the rotating compressing member, and positioning the axle center of the fixed compressing member by the major shaft supporting base; and
(10) providing a top cover, and disposing the top cover on an upper opening of the bottom case for sealing the accommodating space.

16. The method according to claim 15, wherein the connecting manner between the fixed unit and the plurality of first positioning elements is selected from the group consisting of: a screw fastening manner, a welding manner and a close fitting manner.

17. The method according to claim 15, wherein the connecting manner between the major shaft supporting base and the plurality of second positioning elements is selected from the group consisting of: a screw fastening manner, a welding manner and a close fitting manner.

18. The method according to claim 15, wherein the fixed compressing member is connected with the major shaft supporting base, and the connecting manner being selected from the group consisting of: a screw fastening manner and a close fitting manner.

19. The method according to claim 15, wherein the connecting manner of the bottom case and the top cover is selected from the group consisting of: a screw fastening manner, a welding manner and a close fitting manner.
